(19) United States
(12) Patent Application Publication
(10) Pub. No.: US 2015/0375577 A1
(43) Pub. Date: Dec. 31, 2015

(54) PRESSURE SYSTEM FOR A TIRE ASSEMBLY OF A VEHICLE

(71) Applicant: GM GLOBAL TECHNOLOGY OPERATIONS LLC, Detroit, MI (US)

(72) Inventors: Liviu Serbu, Woodbridge (CA); Joseph K. Moore, Whitby (CA)

(21) Appl. No.: 14/317,539

(22) Filed: Jun. 27, 2014

(51) Int. Cl. B60C 23/00; B60C 23/04

(52) U.S. Cl. CPC B60C 23/004; B60C 23/04

(57) ABSTRACT

A pressure system of a tire assembly of a vehicle includes a tire system, a wheel system, and a control valve assembly. The tire system includes a tire defining an interior cavity configured for holding a first volume of compressed air therein. The wheel system defines a reservoir configured for holding a second volume of compressed air therein. The control valve assembly is in fluid communication with each of the interior cavity of the tire and with the reservoir. The control valve assembly is configured to selectively direct air from the reservoir to the interior cavity of the tire such that a desired air pressure within the interior cavity of the tire is achieved. The control valve assembly is configured to selectively direct air from the interior cavity of the tire and atmosphere, such that the desired air pressure within the interior cavity of the tire is achieved.

### TECHNICAL FIELD

The present disclosure is related to a pressure system for a tire assembly of a vehicle.

### BACKGROUND

Certain vehicles have tire pressure monitoring systems. Each tire of the vehicle has a pressure, which is communicated as pressure data to an operator of the vehicle, via a vehicle controller. A pressure sensor and other associated circuitry may be specific to each wheel and the tire mounted thereon. If the communication to the operator indicates that the tire pressure is too low or too high, the operator is required to manually adjust the temperature using an air compressor, a tire gauge, and the like.

### SUMMARY

One aspect of the disclosure provides a pressure system for a tire assembly of a vehicle. The pressure system includes a tire system, a wheel system, and a control valve assembly. The tire system includes a tire defining an interior cavity configured for holding a first volume of compressed air therein. The wheel system defines a reservoir configured for holding a second volume of compressed air therein. The control valve assembly is in fluid communication with the interior cavity of the tire and with the reservoir. The control valve assembly is configured to selectively direct air from the reservoir to the interior cavity of the tire such that a desired air pressure within the interior cavity of the tire is achieved. The control valve assembly is configured to selectively direct air from the interior cavity of the tire to atmosphere, such that a desired air pressure within the interior cavity of the tire is achieved.

Another aspect of the disclosure provides a vehicle including a vehicle controller and a pressure system. The pressure system is in operative communication with the vehicle controller. The pressure system includes a tire system, a wheel system, a control valve assembly, and a control unit. The tire system includes a tire defining an interior cavity configured for holding a first volume of compressed air therein. The wheel system defines a reservoir configured for holding a second volume of compressed air therein. The control valve assembly is in fluid communication with each of the interior cavity of the tire and with the reservoir. The control unit is in operative communication with the control valve assembly and the vehicle controller. The control unit is configured to receive a control signal from the vehicle controller and transmit a corresponding signal to the control valve assembly such that the control valve assembly allows air to flow from the reservoir to the interior cavity of the tire to achieve a desired air pressure within the interior cavity of the tire. The control unit is configured to receive another control signal from the vehicle controller and transmit another corresponding signal to the control valve assembly such that the control valve assembly prevents air from flowing from the reservoir to the interior cavity of the tire once a desired air pressure is achieved within the interior cavity of the tire.

Another aspect of the disclosure provides a pressure system for a tire assembly of a vehicle. The pressure system includes a tire system, a wheel, and a control valve assembly. The tire system includes a tire defining an interior cavity configured for holding a first volume of compressed air therein. The wheel includes a hub, a rim, and a plurality of spokes. The rim surrounds the hub. The spokes radially connect the hub and the rim. The rim defines a border cavity and each of the spokes defines a rib cavity. The border cavity and the rib cavities are in fluid communication with one another to define a reservoir configured for holding a second volume of compressed air therein. The control valve assembly is in fluid communication with each of the interior cavity of the tire and with the reservoir. The control valve assembly is configured to selectively direct air from the reservoir to the interior cavity of the tire such that a desired air pressure within the interior cavity of the tire is achieved. The control valve assembly is configured to selectively direct air from the interior cavity of the tire to atmosphere, such that a desired air pressure within the interior cavity of the tire is achieved.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic block diagram of a vehicle having four tire assemblies and a vehicle controller in communication with each of the tire assemblies.

FIG. 2 is a schematic block diagram of the vehicle including a vehicle controller and a pressure system.

FIG. 3 is another schematic block diagram of the vehicle including the vehicle controller, the pressure system, and an actuator.

FIG. 4 is yet another schematic block diagram of the vehicle including the vehicle controller, the pressure system, and the actuator.

FIG. 5 is a schematic perspective side view of a core insert for forming cavities within a wheel.

FIG. 6 a schematic perspective view of the tire assembly, partially cut away, illustrating the pressure system attached to a wheel of the tire assembly, with the wheel defining cavities formed from the core insert of FIG. 5.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

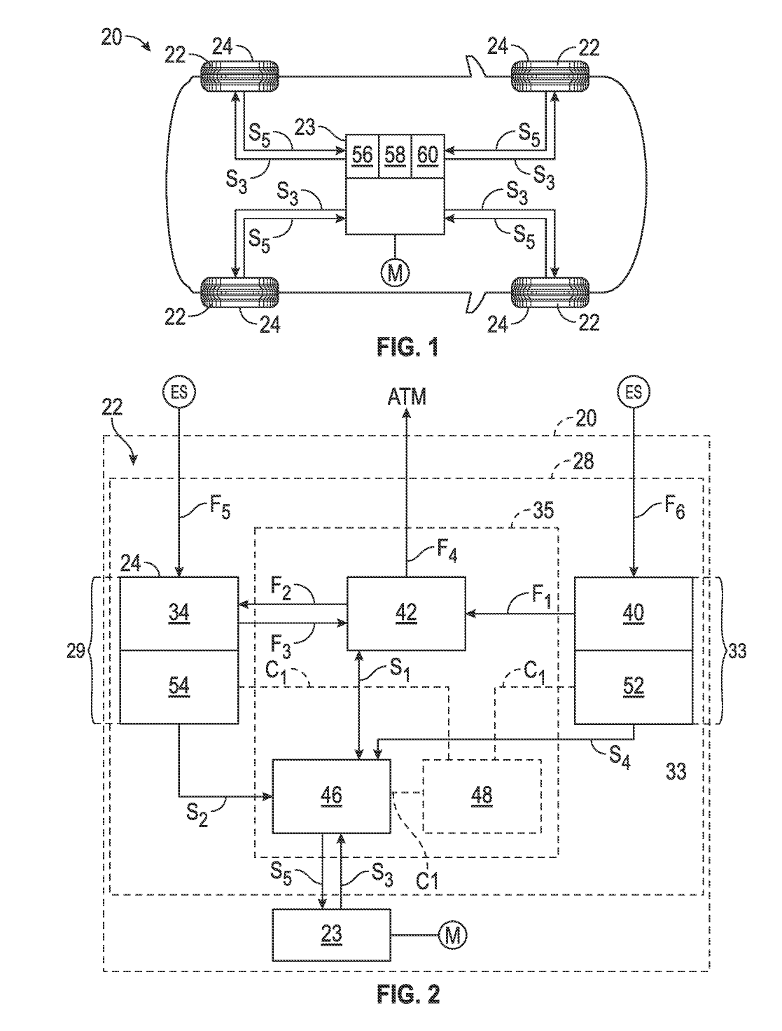

Referring to the Figures, wherein like numerals indicate like parts throughout the several views, a vehicle is generally shown at 20 in FIG. 1. The vehicle 20 includes four tire assemblies 22, each in operative communication with a vehicle controller 23. It should be appreciated that the vehicle 20 is not limited to having four tire assemblies 22, as the vehicle 20 may include any number of tire assemblies 22. With reference to FIG. 2, each tire assembly 22 includes a pressure system 28.

Referring now to FIGS. 1, 2, and 6, the pressure system 28, which is configured to self-regulate an air pressure therein, includes a pressure module 35, a tire system 29, and a wheel system 33. The pressure module 35 is in operative communication with each of the tire system 29 and the wheel system 33. The tire system 29 includes a tire 24 and a tire sensor 54. The wheel system 33 includes a reservoir 40 and a wheel sensor 52. The wheel sensor 52 is configured to determine a pressure and/or temperature within the reservoir 40. The tire 24 is attached to the wheel 26. The tire 24 may include any suitable type, style, size, and/or construction of tire 24, including but not limited to a radial tire or a bias ply tire. The tire sensor 54 is configured to determine a pressure and/or temperature within the interior cavity 34 of the tire 24.

With reference to FIG. 6, the wheel 26 is circular and includes a perimeter 30 that surrounds an axis of rotation 32 of the tire assembly 22. The tire assembly 22 is configured to rotate in a first direction 31A and a second direction 31B, opposite the first direction 31A. The tire 24 is mounted to the wheel 26 at the perimeter 30 such that the perimeter 30 and the tire 24 cooperate to define an interior cavity 34 of the tire 24. The interior cavity 34 of the tire 24 is known as the contained air volume of the tire assembly 22. When the tire 24 is mounted to the wheel 26, the interior cavity 34 is pressurized with gas, such as air, to inflate the tire assembly 22, as is well known.

With reference to FIG. 2, the pressure module 35 includes a control valve assembly 42, a control unit 46, and an energy storage device 48. The control unit 46 is in operative communication with the vehicle controller 23. The control unit 46 is configured to selectively send signals to the control valve assembly 42. The control valve assembly 42 may include one or more valves configured to provide air communication between the interior cavity 34 of the tire 24, the reservoir 40, and atmosphere ATM, in response to the signals S₁ received from the control unit 46.

The energy storage device 48 is in operative communication with the control unit 46, the wheel sensor 52, and the tire sensor 54. The energy storage device 48 is configured to provide electrical current (arrow C1) to the control unit 46, the wheel sensor 52, and the tire sensor 54. In turn, the control unit 46 is configured to selectively send the signal S₁ to the control valve assembly 42. Therefore, the signal S₁ may also be an electrical current.

With continued reference to FIG. 2, the tire sensor 54 is configured to determine a pressure and temperature of air within the interior cavity 34 of the tire 24. The tire sensor 54 is configured to transmit a tire signal (arrow S₂), corresponding to the determined pressure and temperature, to the control unit 46. In turn, the control unit 46 is configured to selectively transmit a status signal (arrow S₃) to the vehicle controller 23 regarding the determined pressure and temperature within the interior cavity 34 of the tire 24. The vehicle controller 23 may determine whether the pressure within the interior cavity 34 of the tire 24 needs to be increased or decreased as a function of the determined pressure and temperature.

The wheel sensor 52 is configured to determine a pressure and temperature within the reservoir 40. The wheel sensor 52 is configured to transmit a signal (arrow S₄) to the control unit 46, corresponding to the determined pressure and temperature. In turn, the control unit 46 is configured to selectively transmit a status signal (arrow S₃) to the vehicle controller 23 regarding the determined pressure and temperature within the reservoir 40. The vehicle controller 23 may determine whether the pressure within the reservoir 40 needs to be increased or decreased as a function of the determined pressure and temperature.

Therefore, the vehicle controller 23 is configured to determine whether the pressure and temperature within the reservoir 40 and the interior cavity 34 of the tire 24 are at a desired pressure and temperature. To make this determination, the vehicle controller 23 may be configured to employ any of a number of computer operating systems and generally include computer-executable instructions, where the instructions may be executable by one or more computers. Computer-executable instructions may be compiled or interpreted from computer programs created using a variety of well-known programming languages and/or technologies, including, without limitation, and either alone or in combination, Java™, C, C++, Visual Basic, Java Script, Perl, etc.

The physical hardware embodying the vehicle controller 23 may include one or more digital computers having a processor 56 and a memory 58, e.g., a read only memory (ROM), random access memory (RAM), electrically-programmable read only memory (EPROM), high speed clock, analog to digital (A/D) and digital to analog (D/A) circuitry, and input/output circuitry and devices (I/O) including one or more transceivers 60 for receiving and transmitting any required signals in the executing of a method, as well as appropriate signal conditioning and buffer circuitry. Any computer-code resident in the vehicle controller 23 or accessible thereby, including an algorithm, can be stored in the memory 58 and executed via the processor(s) 56 to provide the functionality set forth below.

The vehicle controller 23 of FIG. 1 may be configured as a single or a distributed control device. The vehicle controller 23 may be in wireless communication with, or electrically connected to, each of the pressure systems 28 via suitable control channels, e.g, a controller area network (CAN) or serial bus, including for instance any required transfer conductors, whether hard-wired or wireless, sufficient for transmitting and receiving necessary control signals for monitoring and controlling the pressure system 28 of each tire assembly 22 of the vehicle 20.

With continued reference to FIGS. 1 and 2, if the vehicle controller 23 determines that the pressure within the reservoir 40 is too low, the vehicle controller 23 may transmit a message M to alert an operator of the vehicle 20 that the pressure within the reservoir 40 is too low. If the vehicle controller 23 determines the pressure within the reservoir 40 is too high or the pressure within the interior cavity 34 of the tire 24 is too low, the vehicle controller 23 may also transmit a signal (arrow S₅) to the control unit 46 of a respective pressure system 28 of the respective tire assembly 22. In response to receiving the signal (arrow S₅), the control unit 46 is configured to transmit an appropriate signal (arrow S₁) to the control valve assembly 42 such that the control valve assembly 42 actuates until the air pressure within the reservoir 40 is diminished to a desired pressure and/or the pressure within the interior cavity 34 of the tire 24 achieves a desired pressure.

With continued reference to FIG. 2, the control unit 46 may receive a command signal S₃ from the vehicle controller 23 indicating a required pressure to be achieved within the interior cavity 34 of the tire 24. In response, the control unit 46 may transmit a signal S₁ to the control valve assembly 42, instructing the control valve assembly 42 to direct air from the reservoir 40 (arrow F₁) to the interior cavity 34 of the tire 24 (arrow F₂) until the desired air pressure within the interior cavity 34 of the tire 24 is achieved. Once the air pressure is achieved, the vehicle controller 23 may transmit another command signal (arrow S₃) to the control unit 46. In response, the control unit 46 may transmit another signal (arrow S₁) to the control valve assembly 42, instructing the control valve assembly 42 to prevent air from continuing to flow from the reservoir 40 to the interior cavity 34 of the tire 24.

The vehicle controller 23 may determine that the pressure within the interior cavity 34 of the tire 24 needs to be increased. As such, the vehicle controller 23 may transmit a control signal (arrow S₂) to the control unit 46. The control unit 46 may, in turn, send a signal (arrow S₁) to the control valve assembly 42, such that the control valve assembly 42 allows air to flow from the reservoir 40 (arrow F₁) to the interior cavity 34 of the tire 24 (arrow F₂). The control unit 46 is also configured to selectively send another signal (arrow S₁) to the control valve assembly 42, such that the control valve assembly 42 prevents air from flowing from the reservoir 40 to the interior cavity 34 of the tire 24.

With continued reference to FIG. 2, in response to receiving a control signal (arrow S₂) from the vehicle controller 23, the control unit 46 may send a signal (arrow S₁) to the control valve assembly 42 such that the control valve assembly 42 allows air to flow from the interior cavity 34 of the tire 24 (arrow F₃) to atmosphere ATM (arrow F₄). Once a desired air pressure is achieved, the control unit 46 may receive a subsequent control signal (arrow S₂) from the vehicle controller 23. In response, the control unit 46 sends another signal (arrow S₁) to the control valve assembly 42 such that the control valve assembly 42 prevents air from flowing from the interior cavity 34 of the tire 24 to atmosphere ATM.

Additionally, the control valve assembly 42 may be configured to automatically allow air to flow from the interior cavity 34 of the tire 24 to atmosphere ATM in response to a pressure within the interior cavity 34 of the tire 24 exceeding a predefined pressure. As such, the control valve assembly 42 may include at least one one-way valve that is configured to automatically open to release air from the interior cavity 34 of the tire 24 to atmosphere ATM when a pressure within the interior cavity 34 of the tire 24 exceeds a predefined pressure.

The tire assembly 29 may also be configured to receive compressed air from an external source ES (arrow F₅). As such, the tire 24 may include a one-way valve configured to allow pressurized air to be provided into the interior cavity 34 of the tire 24 from the external source ES, when the pressurized air provided by the external source ES is greater than a predefined threshold pressure. The external source ES may be an air compressor, a pump, and the like.

Likewise, the reservoir 40 may be configured to receive compressed air from the external source ES (arrow F₆). The reservoir 40 may include a one-way valve configured to allow pressurized air to be provided into the reservoir 40 from the external source ES, when the pressurized air provided by the external source ES is greater than a predefined threshold pressure.

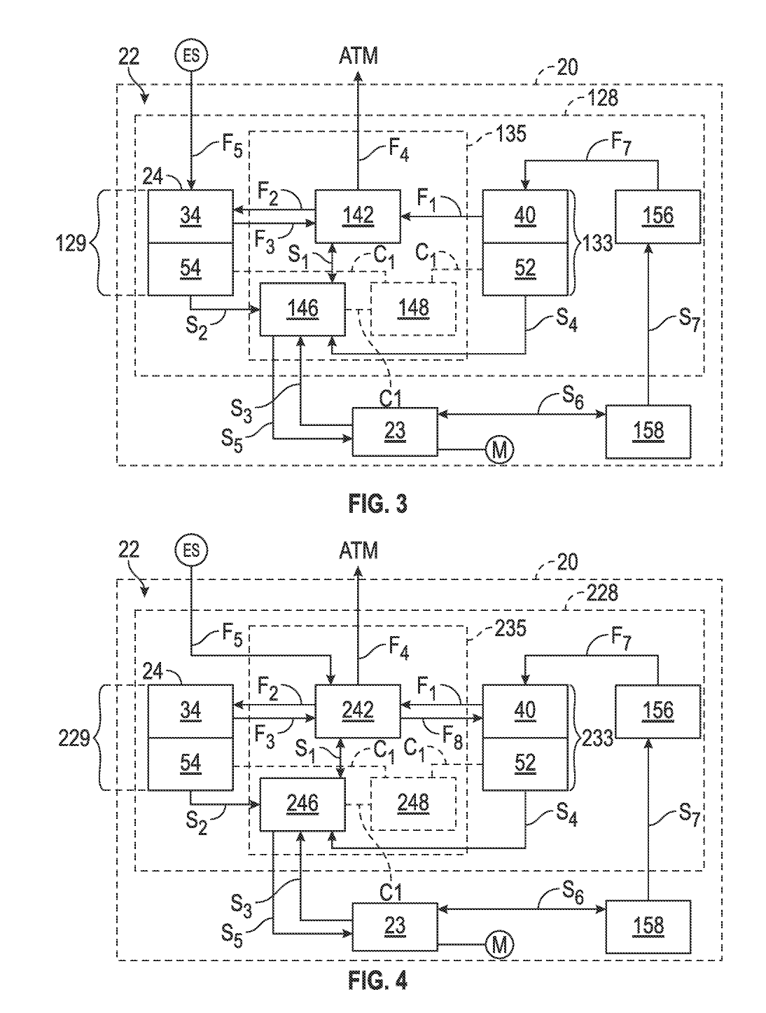

Referring now to FIG. 3, another embodiment of the pressure system 128 is shown. The pressure system 128 includes a pressure module 135, a tire system 129, and a wheel system 133. The pressure module 135 is in operative communication with the tire system 129 and the wheel system 133. The tire system 129 includes a tire sensor 54 and the interior cavity 34 of the tire 24. The wheel system 133 includes a reservoir 40 and a wheel sensor 52.

The pressure module 135 includes a control valve assembly 142, a control unit 146, and an energy storage device 148. The control unit 146 is in operative communication with the vehicle controller 23. The control unit 146 is configured to selectively send signals (arrow S₁) to the control valve assembly 142. As such, the control valve assembly 142 may include one or more valves configured to provide, or otherwise facilitate, air communication between the interior cavity 34 of the tire 24, the reservoir 40, and atmosphere ATM.

The energy storage device 148 is in operative communication with the control unit 146. The energy storage device 148 is configured to provide electrical current (arrow C1) to the control unit 146. In turn, the control unit 146 is configured to selectively send a signal (arrow S₁) to the control valve assembly 142.

With continued reference to FIG. 3, the control unit 146 may receive a command signal S₃ from the vehicle controller 23 to achieve a certain pressure within the interior cavity 34 of the tire 24. In response, the control unit 146 may transmit a signal S₁ to the control valve assembly 142, instructing the control valve assembly 142 to direct air from the reservoir 40 (arrow F₁) to the interior cavity 34 of the tire 24 (arrow F₂) until the desired air pressure within the interior cavity 34 of the tire 24 is achieved. Once the air pressure is achieved, the vehicle controller 23 may transmit another command signal (signal S₃) to the control unit 146. In response, the control unit 146 may transmit another signal (arrow S₁) to the control valve assembly 142, instructing the control valve assembly 142 to prevent air from flowing from the reservoir 40 to the interior cavity 34 of the tire 24.

The control unit 146 is configured to selectively send a signal (arrow S₁) to the control valve assembly 142, such that the control valve assembly 142 allows air to flow from the reservoir 40 (arrow F₁) to the interior cavity 34 of the tire 24 (arrow F₂). The control unit 146 is also configured to selectively send another signal (arrow S₁) to the control valve assembly 142, such that the control valve assembly 142 prevents air from flowing from the reservoir 40 to the interior cavity 34 of the tire 24.

With continued reference to FIG. 3, in response to receiving a command signal (arrow S₅) from the vehicle controller 23, the control unit 146 is configured to selectively send a signal (arrow S₁) to the control valve assembly 142 such that the control valve assembly 142 allows air to flow from the interior cavity 34 of the tire 24 (arrow F₃) to atmosphere ATM (arrow F₄). The control unit 146 is configured to selectively send another signal (arrow S₁) to the control valve assembly 142 such that the control valve assembly 142 prevents air from flowing from the interior cavity 34 of the tire 24 to atmosphere ATM.

With continued reference to FIGS. 1 and 3, if the vehicle controller 23 determines that the pressure within the reservoir 40 is too low, i.e., via signal S₄ received from the wheel sensor 52, the vehicle controller 23 may transmit a message M to alert an operator of the vehicle 20 that the pressure within the reservoir 40 is too low. If the vehicle controller 23 determines the pressure within the reservoir 40 is too high or the pressure within the interior cavity 34 of the tire 24 is too low, i.e., via signals S₂ and/or S₄ received from the respective tire sensor 54 and wheel sensor 52, the vehicle controller 23 may also transmit a signal (arrow S₅) to the control unit 146 of a respective pressure system 128 of the respective tire assembly 22. In response to receiving the signal (arrow S₅), the control unit 146 is configured to transmit an appropriate signal (arrow S₁) to the control valve assembly 142 such that the control valve assembly 142 actuates until the air pressure within the reservoir 40 is diminished to a desired pressure and/or the pressure within the interior cavity 34 of the tire 24 achieves a desired pressure.

Additionally, the control valve assembly 142 may be configured to automatically allow air to flow from the interior cavity 34 of the tire 24 to atmosphere ATM in response to a pressure within the interior cavity 34 of the tire 24 exceeding a predefined pressure. As such, the control valve assembly 142 may include at least one one-way valve that is configured to automatically open to release air from the interior cavity 34 of the tire 24 to atmosphere ATM when a pressure within the interior cavity 34 of the tire 24 exceeds a predefined pressure.

The tire assembly 29 may also be configured to receive compressed air from an external source ES (arrow F₅). As such, the tire 24 may include a one-way valve configured to allow pressurized air to be provided into the interior cavity 34 of the tire 24 from the external source ES, when the pressurized air provided by the external source ES is greater then a predefined threshold pressure. The external source ES may be an air compressor, a pump, and the like.

With continued reference to FIG. 3, the pressure assembly 128 may further include a pump 156. The pump 156 may be in selective fluid communication with the reservoir 40 and in operative communication with an actuator 158. The actuator 158 is in operative communication with the vehicle controller 23. The communication between the actuator 158 and each of the pump 156 and the vehicle controller 23 may be wired, wireless, and the like. When the wheel sensor 52 senses a pressure within the reservoir 40 is too low, the vehicle controller 23 may transmit a signal (arrow S₆) to the actuator 158. In turn, the actuator 158 transmits a signal (arrow S₇) to the pump 156 to initiate operation of the pump 156 to supply compressed air to the reservoir 40 (arrow F₇). When the wheel sensor 52 senses the pressure within the reservoir 40 is at an acceptable pressure level, the vehicle controller 23 transmits a signal (arrow S₆) to the actuator 158 to cease operation of the pump 156. In turn, the actuator 158 transmits another signal (arrow S₇) to the pump 156 to cease operating.

Referring now to FIG. 4, another embodiment of the pressure system 228 is shown. The pressure system 228 includes a pressure module 235, a tire system 229, and a wheel system 233. The pressure module 235 is in operative communication with the tire system 229 and the wheel system 233. The tire system 229 includes a tire sensor 54 and the interior cavity 34 of the tire 24. The wheel system 133 includes a reservoir 40 and a wheel sensor 52.

The pressure module 235 includes a control valve assembly 242, a control unit 246, and an energy storage device 248. The control unit 246 is in operative communication with the vehicle controller 23. The control unit 246 is configured to selectively send signals (arrow S₁) to the control valve assembly 242. As such, the control valve assembly 242 may include one or more valves configured to provide, or otherwise facilitate, air communication between the interior cavity 34 of the tire 24, the reservoir 40, and atmosphere ATM.

The energy storage device 248 is in operative communication with the control unit 246. The energy storage device 248 is configured to provide electrical current (arrow C1) to the control unit 246. In turn, the control unit 246 is configured to selectively send a signal S₁ to the control valve assembly 242.

With continued reference to FIG. 4, the control unit 246 may receive a command signal S₃ from the vehicle controller 23 to increase a pressure within the interior cavity 34 of the tire 24. In response, the control unit 246 may transmit a signal S₁ to the control valve assembly 242, instructing the control valve assembly 242 to direct air from the reservoir 40 (arrow F₁) to the interior cavity 34 of the tire 24 (arrow F₂) until the desired air pressure within the interior cavity 34 of the tire 24 is achieved. Once the air pressure is achieved, the vehicle controller 23 may transmit another command signal (arrow S₃) to the control unit 246. In response, the control unit 246 may transmit another signal (arrow S₁) to the control valve assembly 242, instructing the control valve assembly 242 to prevent air from flowing from the reservoir 40 to the interior cavity 34 of the tire 24.

Alternatively, the control unit 246 may receive a command signal (arrow S₃) from the vehicle controller 23 to reduce the air pressure within the interior cavity 34 of the tire 24. In response, the control unit 246 may transmit a signal (arrow S₁) to the control valve assembly 242, instructing the control valve assembly 242 to direct air from the interior cavity 34 of the tire 24 to the reservoir 40 (arrow F₈) until the required pressure within the interior cavity 34 of the tire 24 is achieved. This air may be stored in the reservoir 40 for later use.

The control unit 246 is configured to selectively send a signal (arrow S₁) to the control valve assembly 242, such that the control valve assembly 242 allows air to flow from the reservoir 40 (arrow F₁) to the interior cavity 34 of the tire 24 (arrow F₂). The control unit 246 is also configured to selectively send another signal (arrow S₁) to the control valve assembly 242, such that the control valve assembly 242 prevents air from flowing from the reservoir 40 to the interior cavity 34 of the tire 24.

With continued reference to FIG. 3, in response to receiving a command signal (arrow S₅) from the vehicle controller 23, the control unit 246 is configured to selectively send a signal (arrow S₁) to the control valve assembly 242 such that the control valve assembly 242 allows air to flow from the interior cavity 34 of the tire 24 (arrow F₃) to atmosphere ATM (arrow F₄). The control unit 246 is configured to selectively send another signal (arrow S₁) to the control valve assembly 242 such that the control valve assembly 242 prevents air from flowing from the interior cavity 34 of the tire 24 to atmosphere ATM.

With continued reference to FIGS. 1 and 4, if the vehicle controller 23 determines that the pressure within the reservoir 40 is too low, the vehicle controller 23 may transmit a message M to alert an operator of the vehicle 20 that the pressure within the reservoir 40 is too low. Also, if the vehicle controller 23 determines the pressure within the reservoir 40 is too high or the pressure within the interior cavity 34 of the tire 24 is too low, the vehicle controller 23 may also transmit a signal (arrow S₅) to the control unit 246 of a respective pressure system 228 of the respective tire assembly 22. In response to receiving the signal (arrow S₅), the control unit 246 is configured to transmit an appropriate signal (arrow S₁) to the control valve assembly 242 such that the control valve assembly 242 actuates until the air pressure within the reservoir 40 is diminished to a desired pressure and/or the pressure within the interior cavity 34 of the tire 24 achieves a desired pressure.

Additionally, the control valve assembly 242 may be configured to automatically allow air to flow from the interior cavity 34 of the tire 24 to atmosphere ATM in response to a pressure within the interior cavity 34 of the tire 24 exceeding a predefined pressure. As such, the control valve assembly 242 may include at least one one-way valve that is configured to automatically open to release air from the interior cavity 34 of the tire 24 to atmosphere ATM when a pressure within the interior cavity 34 of the tire 24 exceeds a predefined pressure.

The control valve assembly 242 may also be configured to receive compressed air from an external source ES (arrow F₅). As such, the control valve assembly 242 include a one-way valve configured to selectively allow pressurized air to be provided to the interior cavity 34 of the tire 24 and/or the reservoir 40 from the external source ES, when the control valve assembly 242 has received a signal (arrow S₁) from the vehicle controller 23 to allow air to be received from the external source ES.

With continued reference to FIG. 4, the pressure assembly 228 may further include the pump 156 and the actuator 158. The pump 156 may be in selective fluid communication with the reservoir 40 and in operative communication with an actuator 258. The actuator 258 is in operative communication with the vehicle controller 23. When the wheel sensor 52 senses a pressure within the reservoir 40 is too low, the vehicle controller 23 may transmit a signal (arrow S₆) to the actuator 258. In turn, the actuator 258 transmits a signal (arrow S₇) to the pump 156 to initiate operation of the pump 256 to supply compressed air to the reservoir 40 (arrow F₇). When the wheel sensor 52 senses the pressure within the reservoir 40 is at an acceptable pressure level, the vehicle controller 23 transmits a signal (arrow S₆) to the actuator 158 to cease operation of the pump 156.

Further, in this embodiment, the vehicle controller 23 may be configured to transmit command signals (arrow S₃) to the control unit 246 to instruct the control valve assembly 242 to selectively lower and raise the air pressure within the interior cavity 34 of the tire 24 to thereby change performance of the ride of the vehicle 20. More specifically, if a larger payload will be included in the vehicle 20, the air may be directed from the reservoir 40 two the interior cavity 34 of the tire 24 to temporarily raise the air pressure therein. Likewise, when a normal payload is being transported by the vehicle 20 the air within the interior cavity 34 of the tire 24 is sent to be stored in the reservoir 40. Further, it should be appreciated that the air pressure within the interior cavity 34 of the tire 24 may be selectively raised and lowered to satisfy different “moding” within the vehicle 20. By way of a non-limiting example, Such molding may include, but should not be limited to, a ride mode, a traction mode, a breaking mode, fuel economy mode, and the like.

Referring now to FIG. 6, the tire assembly 22 is shown as including the wheel 26 and the tire 24, surrounding the wheel 26. The wheel 26 is circular and includes a rim 64, a hub 66, and a plurality of spokes 68. The hub 66 is disposed on the axis of rotation 32. The rim 64 surrounds the hub 66 and the spokes 68 radially connect the hub 66 and the rim 64. While five spokes 68 are shown in FIG. 6, it should be appreciated that the wheel 26 may include any desired number of spokes 68.

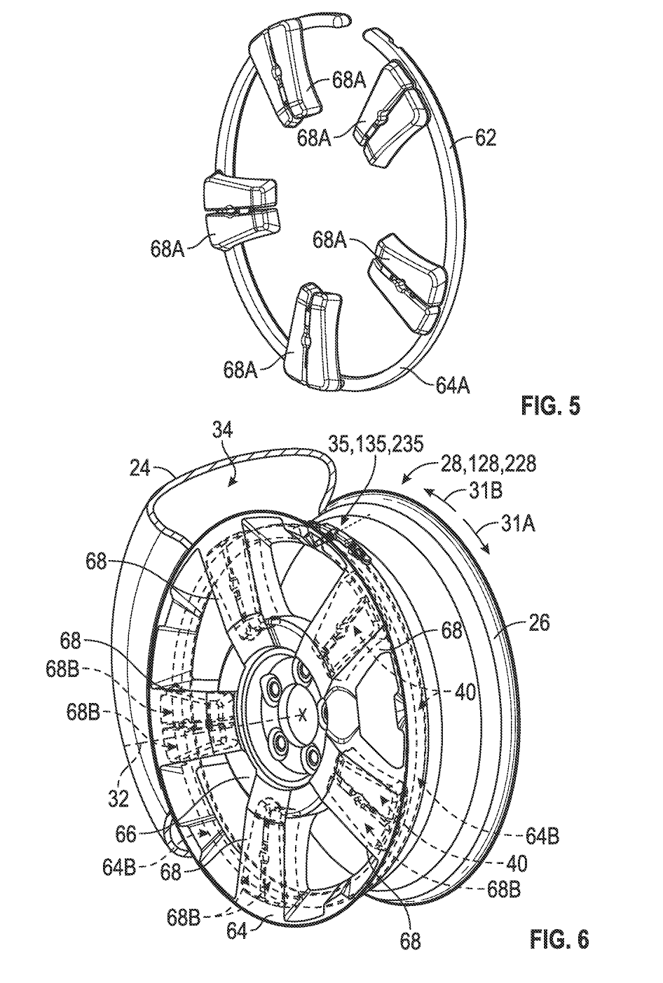

The reservoir 40 may be incorporated as part of the wheel 26 when the wheel 26 is formed or otherwise cast. More specifically, referring to FIGS. 5 and 6, the wheel 26 may be formed to define the reservoir 40 therein. Such a reservoir 40 may be formed using a semi-permanent mold die cast process. A core 62, as shown in FIG. 5, may be used to create the reservoir 40, i.e., hollow cavities, in spokes 68 of the wheel 26. The core 62 may include a border 64A, forming a semicircle. A plurality of ribs 68A extend radially inward, toward one another, from the border 64A. Each rib 68A will correspond to a respective one of the spokes of the wheel 26. Therefore, the number of ribs 68A are equal to the number of spokes 68 within the wheel.

During formation of the wheel 26, the core 62, which is sacrificial, is inserted within a mold or die cavity. Molten metal is introduced to the cavity of the mold and is solidified around the core 62. After casting of the wheel 26, the core 62, which has dissolved during casting, is removed via one or more through holes, formed in the wheel 26 during the casting process. These holes may be plugged with core pads. Alternatively, cylinders for the pump 156 may be operatively disposed within one or more of the through holes.

The reservoir 40 is formed as a negative image of the core 62 within the spokes 68 and the rim 64 of the wheel 26. Therefore, the reservoir 40 is a continuous hollow cavity having a border cavity 64B, forming a semi-circle and a plurality of rib cavities 68B extending radially inward, toward the axis of rotation 32. The pressure module 35, 135, 235 may then be operatively attached to the wheel 26 such that the pressure module 35, 135, 235 is in fluid communication with the reservoir 40 defined within the wheel 26.

By integrating the reservoir 40 within the existing rim 64 and spokes 68 of the wheel 26, packaging efficiency is maximized. Further, the removal of material from within the wheel 26 to define the reservoir 40 enables a mass savings.

While the best modes for carrying out the many aspects of the present teachings have been described in detail, those familiar with the art to which these teachings relate will recognize various alternative aspects for practicing the present teachings that are within the scope of the appended claims.

1. A pressure system for a tire assembly of a vehicle, the pressure system comprising:
a tire system including a tire defining an interior cavity configured for holding a first volume of compressed air therein;
a wheel system defining a reservoir configured for holding a second volume of compressed air therein; and
a control valve assembly in fluid communication with the interior cavity of the tire and with the reservoir;
wherein the control valve assembly is configured to selectively direct air from the reservoir to the interior cavity of the tire such that a desired air pressure within the interior cavity of the tire is achieved; and
wherein the control valve assembly is configured to selectively direct air from the interior cavity of the tire to atmosphere, such that the desired air pressure within the interior cavity of the tire is achieved.

2. A pressure system, as set forth in claim 1, further comprising a control unit in operative communication with the control valve assembly;
wherein the control unit is configured to send a signal to the control valve assembly such that the control valve assembly allows air to flow from the reservoir to the interior cavity of the tire until the desired air pressure within the interior cavity of the tire is achieved; and
wherein the control unit is configured to send another signal to the control valve assembly when the desired air pressure is achieved such that the control valve assembly prevents air from flowing from the reservoir to the interior cavity of the tire.

3. A pressure system, as set forth in claim 2, further comprising an energy storage device in electrical communication with the control unit;
wherein the energy storage device is configured to supply energy to the control unit.

4. A pressure system, as set forth in claim 2, wherein the control unit is configured to send a signal to the control valve assembly such that the control valve assembly allows air to flow from the interior cavity of the tire to atmosphere until the desired air pressure within the interior cavity of the tire is achieved; and
wherein the control unit is configured to selectively send another signal to the control valve assembly when the desired air pressure within the interior cavity of the tire is achieved such that the control valve assembly prevents air from flowing from the interior cavity of the tire to atmosphere.

5. A pressure system, as set forth in claim 4, wherein the control unit is configured to selectively send a signal to the control valve assembly such that the control valve assembly allows air to flow from the interior cavity of the tire to the reservoir until the desired air pressure within the interior cavity of the tire is achieved; and
wherein the control unit is configured to selectively send another to the control valve assembly when the desired air pressure within the interior cavity of the tire is achieved such that the control valve assembly prevents air from flowing from the interior cavity of the tire to the reservoir.

6. A pressure system, as set forth in claim 5, wherein the tire system further includes a tire sensor in operative communication with the interior cavity of the tire and the control unit;
wherein the tire sensor is configured to determine a pressure and temperature of air within the interior cavity of the tire;
wherein the tire sensor is configured to transmit a signal control unit corresponding to the determined pressure and temperature of air within the interior cavity of the tire; and
wherein the control unit is configured to selectively transmit a signal to the control valve assembly, as a function of the determined pressure and temperature within the interior cavity of the tire.

7. A pressure system, as set forth in claim 6, wherein the wheel system further includes a wheel sensor in communication with the interior cavity of the reservoir and the control unit;
wherein the wheel sensor is configured to determine a pressure and temperature within the reservoir;
wherein the wheel sensor is configured to transmit a signal corresponding to the determined pressure and temperature to the control unit; and
wherein the control unit is configured to selectively transmit a signal to the control valve assembly, as a function of the determined pressure and temperature within the reservoir.

8. A pressure system, as set forth in claim 1, wherein the control valve assembly is configured to automatically allow air to flow from the interior cavity of the tire to atmosphere in response to a pressure within the interior cavity of the tire exceeding a predefined pressure.

9. A pressure system, as set forth in claim 1, when the interior cavity of the tire is configured to receive air directly from an external source.

10. A pressure system, as set forth in claim 1, further comprising a pump in fluid communication with the reservoir;
wherein the pump is configured to selectively supply pressurized air to the reservoir.

11. A vehicle comprising:
a vehicle controller; and
a pressure system in operative communication with the vehicle controller, the pressure system including:
a tire system including a tire defining an interior cavity configured for holding first volume of compressed air therein;
a wheel system defining a reservoir configured for holding a second volume of compressed air therein;
a control valve assembly in fluid communication with the interior cavity of the tire and with the reservoir; and
a control unit in operative communication with the control valve assembly and the vehicle controller;
wherein the control unit is configured to receive a control signal from the vehicle controller and transmit a corresponding signal to the control valve assembly such that the control valve assembly allows air to flow from the reservoir to the interior cavity of the tire to achieve the desired air pressure within the interior cavity of the tire; and
wherein the control unit is configured to receive another control signal from the vehicle controller and transmit another corresponding signal to the control valve assembly such that the control valve assembly prevents air from flowing from the reservoir to the interior cavity of the tire once the desired air pressure is achieved within the interior cavity of the tire.

12. A vehicle, as set forth in claim 11, wherein the control valve assembly is configured to receive a control signal from the vehicle controller and transmit a corresponding signal to the control valve assembly to selectively direct air from the interior cavity of the tire to atmosphere until the desired air pressure is achieved within the interior cavity of the tire.

13. A vehicle, as set forth in claim 12, wherein the control unit is configured to receive a control signal from the vehicle controller and transmit a corresponding signal to the control valve assembly such that the control valve assembly allows air to flow from the interior cavity of the tire to atmosphere; and
wherein the control unit is configured to receive another control signal from the vehicle controller and transmit another corresponding signal to the control valve assembly such that the control valve assembly prevents air from flowing from the interior cavity of the tire to atmosphere once the desired air pressure within the interior cavity of the tire is achieved.

14. A vehicle, as set forth in claim 12, wherein the control unit is configured to receive a control signal from the vehicle controller and transmit a corresponding signal to the control valve assembly such that the control valve assembly allows air to flow from the interior cavity of the tire to the reservoir to achieve the desired air pressure within the interior cavity of the tire; and
wherein the control unit is configured to receive another control signal from the vehicle controller and transmit another corresponding signal to the control valve assembly such that the control valve assembly prevents air from flowing from the interior cavity of the tire to the reservoir once the desired air pressure is achieved within the interior cavity of the tire.

15. A vehicle, as set forth in claim 12, wherein the tire system further includes a tire sensor in communication with the interior cavity of the tire and the control unit;
wherein the tire sensor is configured to determine a pressure and temperature of air within the interior cavity of the tire;
wherein the tire sensor is configured to transmit a signal corresponding to the determined pressure and temperature within the interior cavity of the tire to the control unit;
wherein the control unit is configured to transmit the signal corresponding to the determined pressure and temperature within the interior cavity of the tire to the vehicle controller; and
wherein the control unit is configured to receive a control signal from the vehicle controller and transmit a signal to the control valve assembly, as a function of the determined pressure and temperature within the interior cavity of the tire.

16. A vehicle, as set forth in claim 15, wherein the wheel system further includes a wheel sensor in communication with the interior cavity of the reservoir and the control unit;
wherein the wheel sensor is configured to determine a pressure and temperature within the reservoir;
wherein the wheel sensor is configured to transmit a signal corresponding to the determined pressure and temperature within the reservoir to the control unit;
wherein the control unit is configured to transmit the signal corresponding to the determined pressure and temperature within the reservoir to the vehicle controller; and
wherein the control unit is configured to receive a control signal from the vehicle controller and transmit a signal to the control valve assembly, as a function of the determined pressure and temperature within the reservoir.

17. A vehicle, as set forth in claim 11, wherein the control valve assembly is configured to automatically allow air to flow from the interior cavity of the tire to atmosphere in response to a pressure within the interior cavity of the tire exceeding a predefined pressure.

18. A vehicle, as set forth in claim 11, when the interior cavity of the tire is configured to receive air directly from an external source.

19. A vehicle, as set forth in claim 11, further comprising a pump in fluid communication with the reservoir;
wherein the pump is configured to selectively supply pressurized air to the reservoir.

20. A pressure system of a tire assembly of a vehicle, the pressure system comprising:
a tire system including a tire defining an interior cavity configured for holding a first volume of compressed air therein;
a wheel including:
a hub;
a rim surrounding the hub; and
a plurality of spokes radially connecting the hub and the rim;
wherein the rim defines a border cavity and each of the spokes define a rib cavity;
wherein the border cavity and the rib cavities are in fluid communication with one another to define a reservoir configured for holding a second volume of compressed air therein;
a control valve assembly in fluid communication with the interior cavity of the tire and with the reservoir;
wherein the control valve assembly is configured to selectively direct air from the reservoir to the interior cavity of the tire such that a desired air pressure within the interior cavity of the tire is achieved; and
wherein the control valve assembly is configured to selectively direct air from the interior cavity of the tire to atmosphere, such that the desired air pressure within the interior cavity of the tire is achieved.
